(19) United States
(12) Patent Application Publication
(10) Pub. No.: US 2026/0321488 A1
(43) Pub. Date: Oct. 15, 2026

(54) TRANSFORMER COMPONENT AND METHOD FOR MANUFACTURING THE TRANSFORMER COMPONENT

(71) Applicant: TDK Electronics AG, Muenchen (DE)

(72) Inventors: Vladimir Malinovskiy, Muenchen (DE); Mattias Haubner, Muenchen (DE); Hank Zhao, Zhuhai City (CN)

(21) Appl. No.: 19/483,956

(22) PCT Filed: May 14, 2024
(86) PCT No.: PCT/EP2024/063227

§ 371 Date: Nov. 12, 2025

(30) Foreign Application Priority Data
May 15, 2023 (DE) 102023112749.7

(51) Int. Cl. H01F 27/32; H01F 19/00; H01F 27/02; H01F 27/28; H01F 41/00

(52) U.S. Cl. CPC H01F 27/327; H01F 19/00; H01F 27/022; H01F 27/2828; H01F 41/005

(57) ABSTRACT

In an embodiment a transformer component includes at least one winding having a single turn of a wire including a wire insulation and a molded body at least partially embedding the wire including the wire insulation.

### CROSS-REFERENCE TO RELATED APPLICATIONS

This patent application is a national phase filing under section 371 of PCT/EP2024/063227, filed May 14, 2024, which claims the priority of German patent application 102023112749.7, filed May 15, 2023, each of which is incorporated herein by reference in its entirety.

### TECHNICAL FIELD

The present invention is directed to a transformer component, in particular a low-voltage transformer component. A primary and/or secondary winding of the component may be formed by a single turn of a solid wire.

### BACKGROUND

Transformer components are known in which a coil formed from a solid blank copper bar is embedded in a molded body for providing galvanic insulation, mechanical and electrical safety protection and positioning the coil. A minimum wall thickness of the molded body is required to fulfill the norms for electric insulation against hazardous high voltages. The wall thickness and the positioning of the coil has to be closely controlled during injection molding and/or inspected at the finished component, as a slight movement or deformation of the bar during injection molding can lead to that the minimum wall thickness is not achieved.

Also cracks and bubbles in the mold can lead to a reduced insulation. In order to avoid cracks and bubbles in the mold, a sensitive control of process parameters is required, e.g. correct injection pressure, prewarming of injection tools and the copper bar and optimizing mold flow by a proper location and proper number of injection spots. In addition to that, movement of the copper bar during injection molding may be prevented by fixation by gluing or by using a holding device in the mold tool to fix the copper bar. The holding device will be removed from the injection mold tool at the end of the injection process. Thereby, a remaining flow line can occur, leading to cracks in the molded material. Additional glue spots for insulating such weak spots and/or other constructive aids like tape, caps or place holders to separate the winding from the core and/or from the further winding may be applied.

Alternatively, a larger wall thickness than required may be provided to meet the standard also in case of a slight shift or deformation of the copper bar.

All these measures require additional process steps and/or may lead to an enlarged size of the component. Also inspection of the finished plastic part requires additional process steps, such as X-ray inspection to measure the position and minimum wall thickness of the molded body around the winding.

### SUMMARY

Embodiments provide an improved transformer component.

According to one embodiment, a transformer component comprises at least one winding being formed by a single turn of a wire having a wire insulation, and a molded body in which the wire is at least partially embedded.

The winding may be a primary and/or a secondary winding. As an example, one of the windings may be formed by a single turn of a wire and the other one of the windings may be formed by several turns of a wire. The wire for forming the single turn may be thicker than the wire for forming the several turns.

The transformer component may be suitable for low-voltage applications, for example. The transformer component may be used for overload sensing.

When using the wire having a wire insulation instead of a blank wire, galvanic insulation is already provided by the wire insulation. Therefore, the molded body does not have to ensure the required insulation but solely serves to mechanically position the wire and protect the wire from damage during handling or core assembly, for example.

Thereby, the wall thickness of the molded body can be reduced. As an example, a wall thickness may be minimized, e.g. down to 0.2 mm. Also a minimum wall thickness is not critical so that additional measures for preventing movement or bending of the wire during injection molding and inspection of the finished component may be not required. Furthermore, the wire has not to be positioned exactly inside the mold.

The wire may be at least a double-or triple-insulated wire. All layers can be formed by an extrusion process around the wire core. As examples, a double-insulated wire may comprise a first layer comprising ETFE as a material and a second layer comprising FEP as material. A triple-insulated wire may comprise a first layer comprising ETFE as a material, a second layer comprising FEP as material and a third layer comprising PFA as material. Generally, the wire may be any kind of insulated wire which fulfills the safety standards.

The material for the molded body may not require specific insulation properties.

Accordingly, the material can be selected based on cost and/or mechanical properties, for example. As examples, the material may be a thermoplast or a duroplast.

In an embodiment, the wire may be held by a holder for ensuring a stable position during injection molding. The holder may then remain in the finished transformer component. As an example, the wire may be inserted in the holder and the holder may be fixed to the mold before injection molding.

According to a further embodiment, a method for manufacturing a transformer component comprises the steps of providing a wire comprising a wire insulation, wherein the wire forms a single turn, and at least partially embedding the insulated wire in a molded body by injection molding. The transformer component may comprise any structural and/or functional characteristics as described in the foregoing.

The wire may be accommodated in a holder which may be fixed in the mold to ensure a stable position of the wire during injection molding.

The method may further comprise the steps of removing the wire insulation from the wire ends and/or bending the wire ends. The step of removing the insulation may be carried out after injection molding. The step of bending the wire ends may be carried out after removing the insulation. It is also possible, that the insulation at the wire ends and/or bending is carried out before injection molding. A further winding may be wound around a winding section of the molded body.

The present disclosure comprises several embodiments of an invention. Every feature described with respect to one of the embodiments is also disclosed herein with respect to the other embodiments, even if the respective feature is not explicitly mentioned in the context of the specific embodiment.

### BRIEF DESCRIPTION OF THE DRAWINGS

Further features, refinements and expediencies become apparent from the following description of the exemplary embodiments in connection with the figures.

FIG. 1A shows a transformer component in a perspective view according to an embodiment;

FIG. 1B shows a wire forming a winding in the transformer component of FIG. 1A;

FIG. 1C shows a cross-sectional view of the wire at a position inside the molded body in the transformer component of FIG. 1A;

FIGS. 2A-2D show steps in manufacturing a transformer component according to an embodiment;

FIG. 3 shows a longitudinal sectional view of the component in the state of FIG. 2B; and

FIGS. 4A-4C show steps in manufacturing a transformer component according to a further embodiment.

In the figures, elements of the same structure and/or functionality may be referenced by the same reference numerals. It is to be understood that the embodiments shown in the figures are illustrative representations and are not necessarily drawn to scale.

### DETAILED DESCRIPTION OF ILLUSTRATIVE EMBODIMENTS

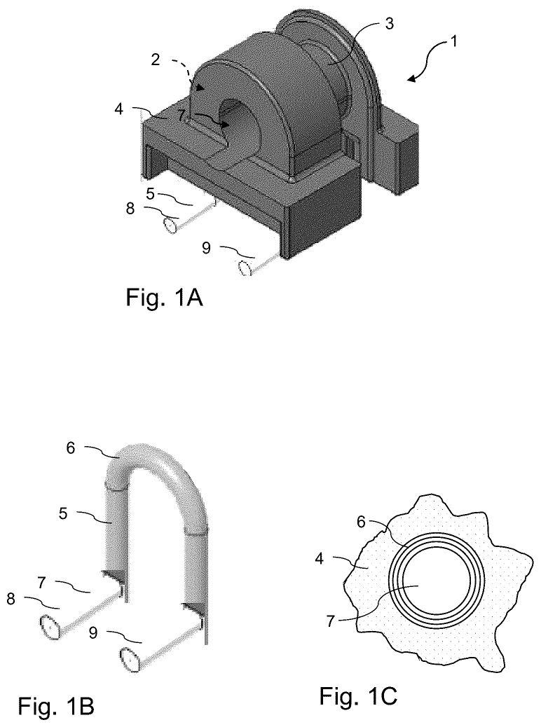

FIG. 1A shows a transformer component 1 comprising a winding 2. The winding 2 may be a primary winding or a secondary winding. The winding 2 is at least partially enclosed in a molded body 4. The molded body 4 comprises an opening 7 for insertion of a magnetic core, e.g. a ferrite core. The molded body 4 can be also denoted as bobbin. The molded body has a winding section 3 for applying a secondary winding. The secondary winding may be formed from several turns of a wire, e.g. a copper wire comprising an insulation according to safety standards or an enamelled copper wire (e.g. Polyurethan G2). The molded body comprises an insulating material, such as plastic.

The transformer component 1 may be configured for low or medium voltage. As an example, a working voltage may be between 300 V and 1200 V. A typical frequency range may be between 50 and 500 kHz. The transformer component 1 may be adapted to use for overload sensing, for example.

The winding 2 is formed by a single turn of an insulated wire 5. The wire 5 ends in two pins 8, 9 for electrically connecting the winding 2.

The wire 5 comprises its own insulation 6, which encloses the wire 5 at least inside the molded body 4. The insulation 6 provides the galvanic and safety insulation of the wire 5. In particular, the winding 2 is galvanically insulated from the core and the secondary winding by the wire insulation 6. The molded body 4 positions the wire 5 and provides a mechanical protection of the wire 5 against damages which may occur during handling, core assembly and/or environmental influences and also provides a mechanical separation from the core and the other winding.

The body 4, however, may not be required for providing the required galvanic insulation. Accordingly, a minimum wall thickness of the body 4 is not required for achieving a galvanic insulation and fulfilling safety requirements for electrical safety in accordance with standards such as IEC standards for electrical safety (e.g. IEC61558). Also a specific material for the molded body 4 is not required.

Previously, when using a blank wire, i.e. without own insulation, a minimum wall thickness of the molded body 4, e.g. 2 mm at a working voltage of 1000 V, was required to fulfil the norm for maximum safety level of a reinforced insulation according to IEC61558, for example. Such an insulation is difficult to achieve and also leads to an enlarged size of the component 1. As the wire protrudes out of the molded body 4 at its ends, the minimum wall thickness is defined as a thickness of the wall around the wire turn but not at the wire ends.

By using the mold-in insulated wire 5 instead of a non-insulated wire, the component 1 can have a smaller size while the required or even improved insulation properties are achieved. In particular, the required insulation for protection against electrical shock is already achieved by the wire insulation 5 while the molded body 4 only protects the insulated wire against damage, e.g. during core assembly, and keeps the molded wire in the correct position for mounting to a PCB via pin-through-hole, for example. As an example, a wall thickness of the molded body, i.e. the minimal distance from the outer side of the wire 5 to the outer side of the molded body 4, can be 0.4 mm instead of the previously 2 mm. Additional elements for mechanical protection of the insulation of the winding 2 like tapes, housing, pottings or caps, are not necessary.

Furthermore, cracks or bubbles in the mold material do not lead to a reduction of the insulation voltage below a required level or partial discharge capability for the winding and to the other winding of the transformer. Accordingly, open spots or bubbles around the insulated wire do not lead to a violation of electric insulation standards. Therefore, a close inspection for cracks or bubbles in the mold material is not required. The transformer component 1 may be free from constructive aids like tapes, caps or place holders to separate the windings.

In addition to that, also the manufacturing process can be simplified, because the wall thickness and the exact position of the insulated wire 5 has not to be inspected during or after manufacturing.

FIG. 1B shows the wire 5 in the form as arranged in the molded body 4, wherein, for illustrating purposes, the molded body 4 is not depicted. The wire 5 comprises a U-shaped form. The form can be also referred to as bracket-shaped. Inside the molded body, the wire 5 has its own insulation 6. The pins 8, 9 protrude out of the molded body 4 and are free from an insulation 6. The insulation 6 may partially be present also outside the molded body 4.

FIG. 1C shows a cross-sectional view of the wire 5 and it's surrounding at a location inside the molded body 4. The wire core 7 is enclosed by the insulation 6. The insulation 6 may be a triple-insulation, i.e. an insulation with three layers. The wire core 7 may be also a Litz wire as long as the outer insulation fulfils the required safety standards. The material of the insulation 6 may be different from the material of the molded body 4.

For achieving the same required insulation properties, the minimum thickness of the wire insulation 6 can be generally much smaller than for a solid material provided by a molded body 4. As the required insulation property is provided by the wire insulation 6, the component can have a smaller overall size.

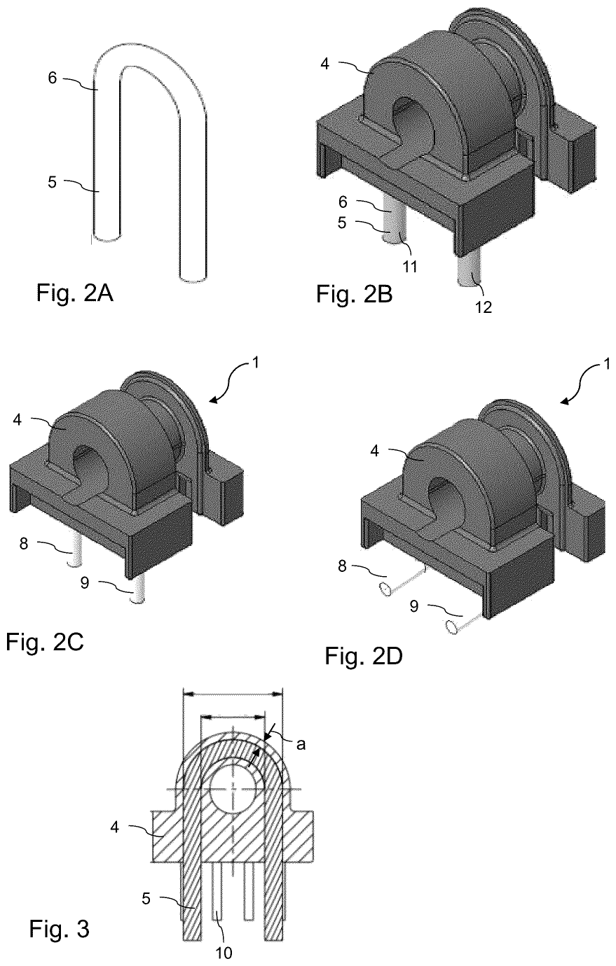

FIGS. 2A-2D show steps in manufacturing a transformer component 1, in particular the transformer component of FIG. 1A.

As shown in FIG. 2A, in a first step, a wire 5 for forming a winding 2 is provided.

The wire 5 may alternatively form a secondary winding. The wire 5 comprises an insulation 6.

The insulation 6 is present along the entire length of the wire. The wire 5 has a U-shaped geometry.

In FIG. 2B, the wire 5 is positioned in a mold tool and partly embedded in a molded body 4 by injecting material for the molded body 4 in the mold tool. As an example, one-shot injection molding may be used. The wire 5 may be fully enclosed by the molded body 4 except from the wire ends 11, 12. The wire ends 11, 12 protrude out of the molded body 4 and are still insulated along their entire lengths.

In the same step, pins for the secondary winding may be positioned in the mold tool and partially embedded by injection molding, for example. The secondary pins may be in the form of a leadframe, for example.

In the step shown in FIG. 2C, the wire insulation 6 is removed at the wire ends 11, 12 such that uninsulated pins 8, 9 for electrical connection of the winding 2 are formed. As an example, laser stripping may be used for removing the insulation 6.

In the step shown in FIG. 2D, the pins 8, 9 are bend, e.g. to an L-formed shape.

Also the pins for the secondary winding may have an L-formed shape. Wire ends of the secondary winding may be connected to the respective pins. As an example, the wire ends of the further winding may be wrapped around the pins and fixed by soldering or gluing. The transformer 1 may be configured to be mounted on a PCB via surface-mounting or pin-through-hole mounting, for example.

When using the wire ends 11, 12 as pins 7, 8, the creepage and clearance distances are ensured by the stable positioning in the molded body. As a result, the tolerances and size of the wire end area may be smaller than with wire wrapped pins, which require additional space for wrapping and solder joint. Thereby, a smaller overall size can be achieved.

Furthermore, wire ends 11, 12 may be cut to achieve a desired length of the pins 8, 9. The bending and/or cutting step may be optional steps and may be not required for all transformer designs.

FIG. 3 shows a longitudinal sectional view of the component in the process step of FIG. 2B. The minimum wall thickness from an outer surface of the insulated wire 5 to a surface of the molded body 4 is 1 mm or less, for example. As an example, the minimum wall thickness may be 0.2 mm. The minimum wall thickness a maybe also a distance to the surface of the molded body 4 next to the core. The thickness of the wire may by about 1 mm, for example. In this view also several pins 10 for the secondary winding are visible.

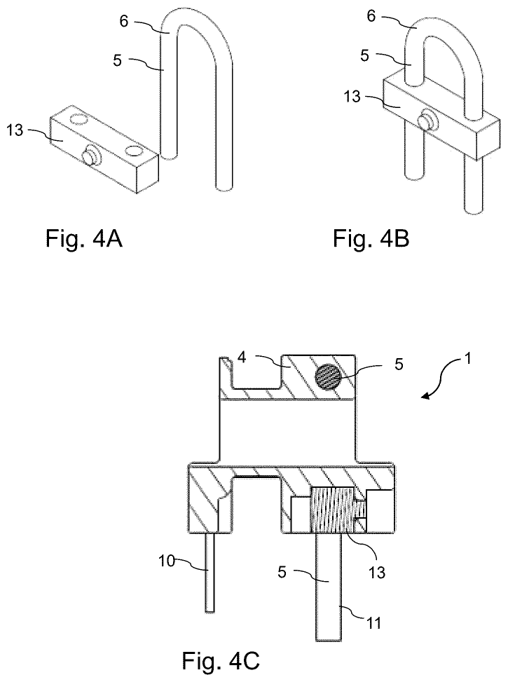

FIGS. 4A-4C show steps in manufacturing a transformer component 1 according to a further embodiment. The wire 5 can be as described in the foregoing and comprises a wire insulation 6.

As shown in FIG. 4A, a holder 13 is provided for securely positioning the wire 5 comprising the wire insulation 6 in the mold. The holder 13 may be a plastic holder.

As shown in FIG. 4B, the wire 5 is inserted in the holder 13 and the wire 5 is positioned with the holder 13 thereafter in the mold. The holder 13 may be fixed to the mold. It is also possible that the holder 13 is fixed in the mold when the wire 5 is inserted in the holder 13. After that, the molded body 4 is formed around the wire 5 and the holder 13 by injection molding.

FIG. 4C shows the resulting transformer component 1 with the holder 13 being a part of the finished component 1. The wire ends 11, 12 protrude out of the molded body 4 and the wire insulation may be removed at the wire ends 11, 12 before or after injection molding. Also the bending process is the same as for the other embodiments.

1.-11. (canceled)

12. A transformer component comprising:
at least one winding having a single turn of a wire comprising a wire insulation; and
a molded body at least partially embedding the wire including the wire insulation.

13. The transformer component of claim 12, wherein a minimum wall thickness from an outer side of the wire insulation to a surface of the molded body is not more than 1 mm.

14. The transformer component of claim 12, wherein the wire is at least a double-or triple-insulated wire.

15. The transformer component of claim 12, wherein a material of the molded body comprises a thermoplast or a duroplast.

16. The transformer component of claim 12, wherein the winding is a primary winding and/or a secondary winding.

17. The transformer component of claim 12, wherein the winding is U-shaped.

18. The transformer component of claim 12, further comprising a holder, wherein the wire is positioned in the holder, and wherein the holder and the wire is at least partially embedded in the molded body.

19. A method for manufacturing the transformer component of claim 12, the method comprising:
providing the wire with the wire insulation; and
at least partially embedding the wire in the molded body by injection molding.

20. The method of claim 19, further comprising removing the insulation from the wire at wire ends.

21. The method of claim 20, further comprising bending the wire ends.

22. The method of claim 19, further providing a holder, wherein the wire is held by the holder for ensuring a stable position in a mold during the injection molding.
